(19) United States
(12) Patent Application Publication
(10) Pub. No.: US 2026/0213402 A1
(43) Pub. Date: Jul. 23, 2026

(54) ANTENNA AND ELECTRONIC DEVICE HAVING ANTENNA

(71) Applicant: HUAWEI TECHNOLOGIES CO., LTD., Shenzhen, Guangdong (CN)

(72) Inventors: Jinglei ZHANG, Xi'an (CN); Yun ZHANG, Xi'an (CN); Liang LU, Xi'an (CN); Xiaoguo ZHANG, Xi'an (CN); Yongchao LIU, Xi'an (CN)

(21) Appl. No.: 19/140,743

(22) PCT Filed: Nov. 21, 2023
(86) PCT No.: PCT/CN2023/132976

§ 371 Date: Jun. 18, 2025

(30) Foreign Application Priority Data
Dec. 19, 2022 (CN) 202211635488.6

(51) Int. Cl. H01Q 1/50; H01Q 1/22; H01Q 1/42

(52) U.S. Cl. CPC H01Q 1/50; H01Q 1/22; H01Q 1/42

(57) ABSTRACT

An antenna and an electronic device. The antenna includes a first radiator, a feed source, and a filter circuit. The first radiator includes a feed point, a filtered-wave return-to-ground point, a first end portion and a second end portion, the feed point and the filtered-wave return-to-ground point are disposed between the first end portion of the first radiator and the second end portion of the first radiator; the feed source is electrically connected to the feed point of the first radiator, to feed a radio frequency signal into the first radiator; and the filter circuit is electrically connected to the filtered-wave return-to-ground point, the filter circuit is configured to enable a radio frequency signal in a first band to pass through and ground a radio frequency signal in a second band, and a length of the first radiator is one half of an operating wavelength corresponding to the first band.

### CROSS-REFERENCE TO RELATED APPLICATIONS

This application is a national stage of International Application No. PCT/CN2023/132976, filed on Nov. 21, 2023, which claims priority to Chinese Patent Application No. 202211635488.6, filed on Dec. 19, 2022. Both of the aforementioned applications are hereby incorporated by reference in their entireties.

### TECHNICAL FIELD

This application relates to the field of antenna technologies, and in particular, to an antenna and an electronic device having the antenna.

### BACKGROUND

With rapid development of electronic technologies, electronic devices with a communication function, such as mobile phones, are increasingly popularized. An electronic device usually includes an antenna apparatus to implement a communication function of the electronic device. Usually, in the antenna apparatus, a frequency in a low band and a frequency in a middle/high frequency are usually separately fed. Such an antenna apparatus has low radiation efficiency in the low band in case of a small clearance area, and the antenna apparatus usually uses a direct return-to-ground manner. Consequently, the antenna apparatus cannot use a specific absorption rate (SAR) sensor.

### SUMMARY

This application provides an antenna and an electronic device. With the antenna in this application and the electronic device having the antenna, low band efficiency can be improved, and bandwidth expansion and SAR reduction can be implemented.

According to a first aspect, this application provides an antenna structure of an electronic device, where an antenna may include a first radiator, a feed source, and a filter circuit. The first radiator includes a feed point and a filtered-wave return-to-ground point, the first radiator further includes a first end portion and a second end portion, and the feed point and the filtered-wave return-to-ground point are disposed between the first end portion of the first radiator and the second end portion of the first radiator; the feed source is electrically connected to the feed point of the first radiator, to feed a radio frequency signal into the first radiator; and the filter circuit is electrically connected to the filtered-wave return-to-ground point, the filter circuit is configured to enable a radio frequency signal in a first band to pass through and ground a radio frequency signal in a second band, and a length of the first radiator is one half of an operating wavelength corresponding to the first band.

It may be learned that the antenna provided in the first aspect can improve low band efficiency and implement bandwidth expansion. The antenna structure can also achieve a balance between a middle/high band (MHB) low SAR and low band (LB) radiation performance. That is, a slot position of the antenna is designed, to adjust a strength of a coupling current of a frame body position and a slot are adjusted, so as to affect distribution concentration and dispersion degrees of a current on the frame body of the antenna.

In one implementation, the antenna further includes a second radiator, the second radiator is configured to disperse current distribution of the first radiator, the second radiator includes a first end portion and a second end portion, the first end portion of the second radiator is disposed close to the second end portion of the first radiator, the second end portion of the second radiator is disposed away from the first radiator, and a first slot exists between the first end portion of the second radiator and the second end portion of the first radiator. In this application, the first radiator couples the radio frequency signal to the second radiator by using the first slot. The first radiator may be used as a main branch of the antenna, and the second radiator is used as a parasitic branch of the first radiator, so as to achieve a purpose of current distribution, so that the antenna can operate in a middle/high band and features a relatively low SAR, thereby improving radiation efficiency and expanding a frequency bandwidth.

In one implementation, the second radiator further includes a ground point, and the ground point may be disposed between the first end portion of the second radiator and the second end portion of the second radiator.

In one implementation, the antenna further includes a first switching point, the first switching point may be disposed on the first radiator and located between the feed point and the filtered-wave return-to-ground point, and the first switching point may be grounded by using a first switching circuit. Based on such a design, the antenna in this application may adjust radiation frequency of the first radiator by using the first switching circuit.

In one implementation, the antenna further includes a second switching point, the second switching point is disposed between the first end portion and the ground point of the second radiator, the second switching point is grounded by using the second switching circuit, and the second switching circuit is configured to adjust a radiation frequency of the second radiator. Based on such a design, the antenna in this application may adjust the radiation frequency of the second radiator by using the second switching circuit.

In one implementation, the first switching point and the feed point are disposed on the first radiator and adjacent to the first end portion of the first radiator, and the feed point is located between the first switching point and the second end portion of the first radiator.

In one implementation, the filtered-wave return-to-ground point is located between the first switching point and the first end portion of the first radiator, and a distance between the filtered-wave return-to-ground point and the second end portion of the first radiator is less than one half of a length of the first radiator.

According to a second aspect, this application provides an electronic device, where the electronic device includes the foregoing antenna.

In one implementation, the electronic device includes a frame body, the frame body includes a first side frame, and a second side frame and a third side frame that are disposed opposite to each other, where the first side frame is connected between the second side frame and the third side frame, a part of the second side frame is the first radiator, and a part of the second side frame and a part of the first side frame are the second radiator.

In one implementation, the electronic device further includes a backplane and a display unit, where the backplane is disposed on an edge of the frame body, and the display unit is disposed on a side that is of the frame body and that is away from the backplane. The backplane is made of metal or another conductive material. Certainly, the backplane may alternatively be made of an insulating material such as glass or plastic. That is, the antenna structure may be adapted to the electronic device with the backplane made of different materials. In addition, the antenna structure may be adapted to the electronic device with a large screen such as a curved screen and a thinner (narrower) side metal frame body.

In one implementation, the electronic device further includes a housing; and the frame body is disposed in the housing, and is integrated with the housing through insert molding.

The antenna and the electronic device provided in this application can significantly improve low band efficiency, and implement bandwidth expansion and SAR reduction. The antenna structure in this application may implement both middle/high band (MHB) low SAR and low band (LB) radiation performance. That is, a slot position of the antenna is designed, to adjust a strength of a coupling current of a frame body position and a slot are adjusted, so as to affect distribution concentration and dispersion degrees of a current on the frame body of the antenna.

### BRIEF DESCRIPTION OF DRAWINGS

FIG. 1 is a diagram of a structure of an antenna used in an electronic device according to an embodiment of this application;

FIG. 2 is a diagram of the electronic device shown in FIG. 1 from another angle;

FIG. 3 is a cross-sectional view along a line III-III in the electronic device shown in FIG. 1;

FIG. 4 is a circuit schematic of the antenna shown in FIG. 1;

FIG. 5 is a schematic of a current direction during operation of the antenna shown in FIG. 4;

FIG. 6 is a diagram of a structure of a switch unit shown in FIG. 4;

FIG. 7 is a curve diagram of an S parameter (scattering parameter) of the antenna; and

FIG. 8 is a curve diagram of radiation efficiency of the antenna.

### DESCRIPTION OF EMBODIMENTS

Unless otherwise defined, all technical and scientific terms used in this specification have same meanings as those usually understood by a person skilled in the art of this application. The terms used in the specification of this application are merely for the purpose of describing embodiments, and are not intended to limit this application. The term “and/or” used in this specification includes any and all combinations of one or more of the related listed items.

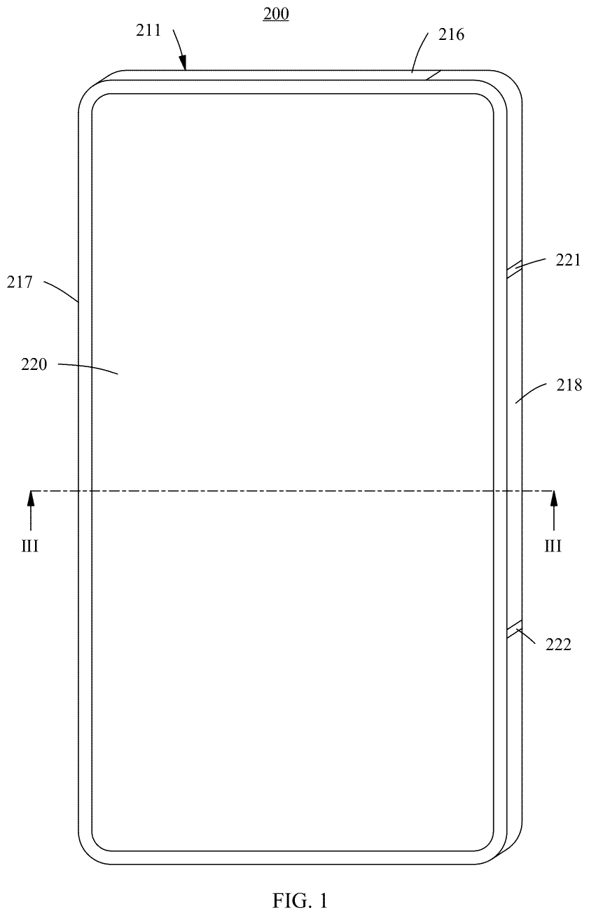

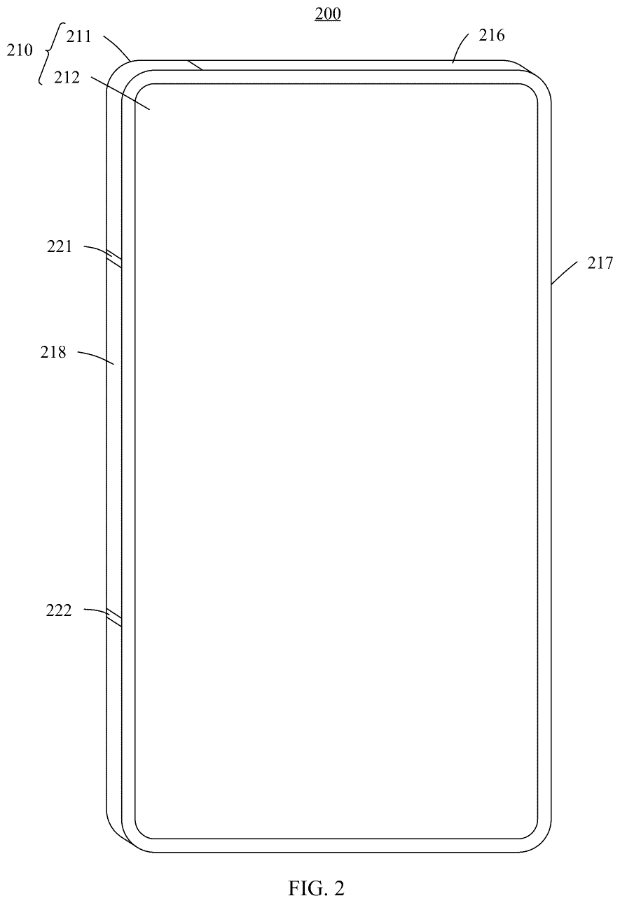

Refer to FIG. 1 and FIG. 2. An embodiment of this application provides an antenna 100. The antenna 100 may be used in an electronic device 200 such as a mobile phone, a tablet computer, or a personal digital assistant (PDA), and is configured to transmit and receive radio waves to transmit and exchange radio signals.

It may be understood that the electronic device 200 may use one or more of the following communication technologies: a Bluetooth (BT) communication technology, a global positioning system (GPS) communication technology, a wireless fidelity (Wi-Fi) communication technology, a global system for mobile communications (GSM) communication technology, a wideband code division multiple access (WCDMA) communication technology, a long term evolution (LTE) communication technology, a 5G communication technology, a SUB-6G communication technology, and another future communication technology.

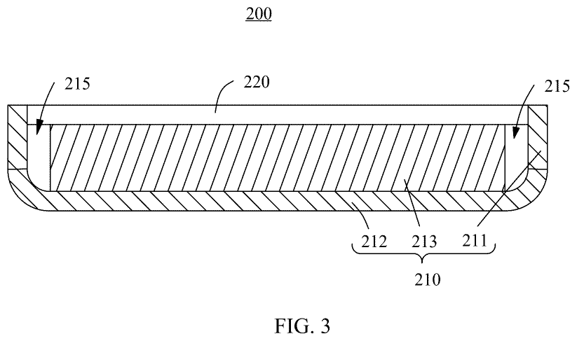

Also refer to FIG. 3. The electronic device 200 may include a housing 210 and a display unit 220. The housing 210 includes at least a side frame 211, a backplane 212, and a system ground portion 213.

The side frame 211 is approximately annular in structure, and is made of metal or another conductive material. The backplane 212 is disposed at an edge of the side frame 211. The backplane 212 may be made of metal or another conductive material. Certainly, the backplane 212 may also be made of an insulation material, such as glass, plastic, or ceramic.

The system ground portion 213 may be made of metal or another conductive material. The system ground portion 213 is directly connected to the side frame 211, and is configured to provide grounding for the antenna 100.

It may be understood that, in this embodiment, there is a clearance area 215 between an edge of the system ground portion 213 and the side frame 211.

It may be understood that, in some other embodiments of this application, the side frame 211 and the system ground portion 213 may form an integrated metal frame body.

It may be understood that, in another embodiment, the electronic device 200 may further include one or more of the following components: for example, a processor, a circuit board, a memory, a power supply component, an input/output circuit, an audio component (for example, a microphone and a speaker), a multimedia component (for example, a front-facing camera and/or a rear-facing camera), a sensor component (for example, a proximity sensor, a distance sensor, an ambient light sensor, an acceleration sensor, a gyroscope, a magnetic sensor, a pressure sensor, and/or a temperature sensor). Details are not described herein again.

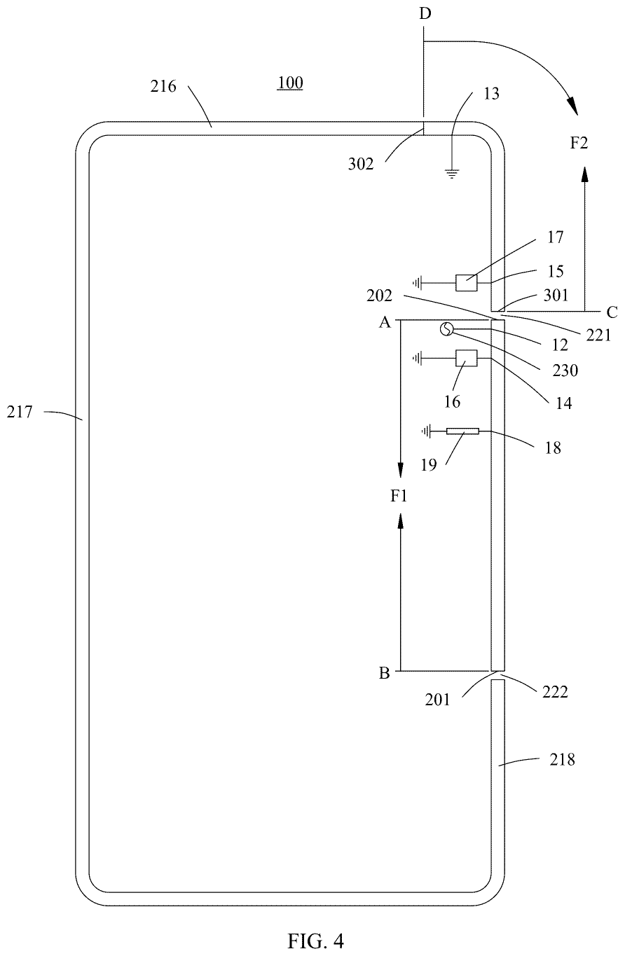

Also refer to FIG. 4. The antenna 100 includes at least a first radiator F1, a second radiator F2, and a feed source 230.

The first radiator F1 may include a first end portion 201 and a second end portion 202, and the second radiator F2 may include a first end portion 301 and a second end portion 302. The first end portion 301 of the second radiator F2 is disposed close to the second end portion 302 of the first radiator F1, and the second end portion 302 of the second radiator F2 is disposed away from the first radiator F1.

The first radiator F1 may further include a feed point 12, a first switching point 14, and a second switching point 15, and the second radiator F2 may further include a ground point 13.

In this embodiment, the feed point 12 is disposed between the first end portion 201 and the second end portion 202 of the first radiator F1. The feed source 230 is electrically connected to the feed point 12. Based on such a design, the feed source 230 may feed a radio frequency signal into the first radiator F1.

The side frame 211 includes at least a first part 216, a third part 217, and a second part 218.

In this embodiment, the first part 216 is one end of the frame body of the electronic device 200. For example, the first part 216 is a top metal side frame of the electronic device 200, and the third part 217 and the second part 218 are disposed opposite to each other. The third part 217 and the second part 218 may be respectively disposed at two ends of the first part 216. For example, the third part 217 and the second part 218 may be respectively connected to the two ends of the first part 216.

In this embodiment, lengths of the third part 217 and the second part 218 are both greater than a length of the first part 216. That is, both the third part 217 and the second part 218 are metal side frames of the electronic device 200. The antenna 100 in this embodiment forms a side antenna of the electronic device 200.

At least one slot may be further provided on the side frame 211. In this embodiment, two slots, that is, a first slot 221 and a second slot 222, are provided on the side frame 211. The first slot 221 and the second slot 222 are spaced apart from each other on the second part 218.

It may be understood that, in this embodiment, both the first slot 221 and the second slot 222 run through and separate the side frame 211. The at least one slot jointly separates the side frame 211 to obtain at least two radiators. In this embodiment, the first slot 221 and the second slot 222 jointly separate the side frame 211 to obtain the first radiator F1 and the second radiator F2.

In this embodiment, as shown in FIG. 4, a first metal segment AB of the side frame 211 is the first radiator F1 in this embodiment, and a second metal segment CD of the side frame 211 is the second radiator F2 in this embodiment.

In some embodiments, the first radiator F1 is disposed on a right side of the electronic device 200, that is, includes a part of the second part 218. In some embodiments, a length of the first radiator F1 may be one half of an operating wavelength corresponding to a first band. The second radiator F2 is disposed at an upper right corner of the electronic device 200, that is, includes a part of the first part 216 and a part of the second part 218. It may be understood that the first band mentioned above may range from 698 MHz to 960 MHz.

There is no physical connection between the first end portion 301 of the second radiator F2 and the second end portion 202 of the first radiator F1, and the first slot 221 is formed between the first end portion 301 of the second radiator F2 and the second end portion 202 of the first radiator F1. An electrical length of the first radiator F1 is greater than an electrical length of the second radiator F2. It may be understood that, in some embodiments, the first slot 221 and the second slot 222 may be filled with an insulation material, for example, plastic, rubber, glass, wood, or ceramic, but this is not limited.

It may be understood that, in this embodiment, widths of the first slot 221 and the second slot 222 are both very small, for example, may be set to 0.5 mm to 2 mm. In one solution, the widths of the first slot 221 and the second slot 222 may be both set to 0.8 mm, 1 mm, or 1.2 mm.

The feed point 12 is located in the second part 218. It may be understood that, in some possible implementations, the feed point 12 may be electrically connected to the feed source 230 by using a spring, a microstrip, a strip line, a coaxial cable, or the like. The feed source 230 may feed a radio frequency signal into the first radiator F1 by using a spring, a microstrip, a strip line, a coaxial cable, or the like.

In one implementation, the feed point 12 may be made of a material such as metal, a metal copper foil, or a conductor in a laser direct molding (LDS) process.

The ground point 13 is disposed between the first end portion 301 and the second end portion 302 of the second radiator F2, and the ground point 13 is disposed close to the second end portion 302 of the second radiator F2. The ground point 13 is electrically connected to the system ground portion 213, that is, grounded. It may be understood that, in this embodiment, the antenna 100 may further include a first tuning unit 16. The first switching point 14 may be disposed on the first radiator F1, and is located in the second part 218. The first switching point 14 may be electrically connected to the system ground portion 213 by using the first tuning unit 16, that is, grounded. The first tuning unit 16 is configured to perform port matching and frequency adjustment on the first radiator F1. It may be understood that, in this embodiment of this application, the first tuning unit 16 is used to adjust the electrical length of the first radiator F1, so that a band of a radiation signal of the first radiator F1 can be adjusted. It may be understood that the first tuning unit 16 may be used as the first switching circuit in this application.

It may be understood that, in some embodiments, the feed point 12 may be disposed on the first radiator F1 and located between the first switching point 14 and the second end portion 202.

It may be understood that, in this embodiment, the antenna 100 may further include a second tuning unit 17. The second switching point 15 is disposed on the second radiator F2, and is located in the second part 218. The second switching point 15 may be electrically connected to the system ground portion 213 by using the second tuning unit 17, that is, grounded. The second tuning unit 17 is configured to perform port matching and frequency adjustment on the second radiator F2. It may be understood that the second tuning unit 17 may be used as the second switching circuit in this application.

That is, the first switching point 14 is disposed on the first radiator F1 and adjacent to the second end portion 202, the second switching point 15 is disposed on the second radiator F2 and adjacent to the first end portion 301, and the first switching point 14 and the second switching point 15 are respectively grounded by using corresponding tuning units.

It may be understood that with development of information technologies, the public enjoys convenience brought by the information technologies and also focuses on harm of electromagnetic radiation of wireless communication terminals to human bodies. A specific absorption rate (SAR) is an important indicator of a mobile phone and is also a special concern for an antenna engineer during antenna design. Usually, a total radiated power (TRP) of the electronic device is closely associated with the SAR. However, in actual antenna design, radiation power of a mobile phone is reduced to control the SAR under normal conditions. However, if the SAR is controlled by reducing the radiated power of the mobile phone, there is no doubt that not only the wireless performance of the product is affected, but also the user experience is affected. In addition, the competitiveness of the product is reduced.

In the antenna 100 in this application, the second radiator F1 is disposed as a parasitic antenna branch, so that a current distribution area of the first radiator F1 may be increased, and then the second metal segment (that is, the CD segment) in the side frame 211 forms a parasitic branch. In other words, the first radiator F1 is a main antenna branch of the antenna 100, and the second radiator F2 forms a parasitic branch of the first radiator F1, so as to achieve a purpose of current distribution, so that the antenna 100 can operate in a middle/high band and features a relatively low SAR, thereby improving radiation efficiency and expanding a frequency bandwidth.

It may be understood that, in this embodiment, the antenna 100 may further include a filtered-wave return-to-ground point 18 and a filter circuit 19. The second filtered-wave return-to-ground point 18 is disposed on the first radiator F1, the filtered-wave return-to-ground point 18 is located between the first end portion 201 and the second end portion 202 of the first radiator F1, and the filtered-wave return-to-ground point 18 is electrically connected to the system ground portion 213 by using the filter circuit 19. It may be understood that the filtered-wave return-to-ground point 18 is disposed on the frame body 211 and on one end close to the feed point 12 and the first slot 221. For example, a distance between the filtered-wave return-to-ground point 18 and the second end portion 202 is less than one half of a length of the first radiator F1.

In this embodiment, the filter circuit 19 may include a capacitor and an inductor. It may be understood that the filter circuit 19 is configured to enable a signal in the first band to pass through, and ground a signal in the second band. Frequencies in the first band and the second band are different. For example, the first band may be a low-frequency signal, and the second band may be a high-frequency signal.

It may be understood that, because the filter circuit 19 is disposed on the first radiator F1, the signal in the first band that is fed by the feed source 230 can pass through the filter circuit 19, and the filter circuit 19 blocks the signal in the second band that is fed by the feed source 230 from passing through, and the signal in the second band is grounded. In this way, it is equivalent to that the antenna 100 in this application implements, on one radiator, functions of equivalent antennas in two band ranges, so that the antenna apparatus has a good matching status and has multi-frequency performance, and therefore extends antenna bandwidth and can be used in a multi-frequency terminal. In other words, in this application, the filter circuit disposed on the first radiator allows a frequency in a low band and a frequency in a middle/high band to share a radiator and a feed source.

The feed source 230 feeds a radio frequency signal to excite the first radiator F1, so that the first radiator F1 generates an electromagnetic wave radiated to surrounding space, and a function of transmitting the signal in the first band by the antenna can be implemented. It may be understood that, in this embodiment, the electrical length of the first radiator F1 is adjusted, so that the electrical length of the first radiator F1 is about half of an operating wavelength corresponding to a low band, thereby improving low band efficiency by more than 1.5 dB.

A radiation mode of the antenna 100 in this application is a longitudinal mode. It may be understood that the longitudinal mode may refer to a radiation mode that the longitudinal lateral metal side frame (for example, the second part 218) serves as a main radiator to radiate outward. The antenna 100 may provide a slot on a side of the antenna 100, for example, provide a slot in the second part 218 (that is, the first slot 221), to assist in providing a longitudinal component of a side radiator, so as to ensure that the antenna 100 has good LB radiation performance.

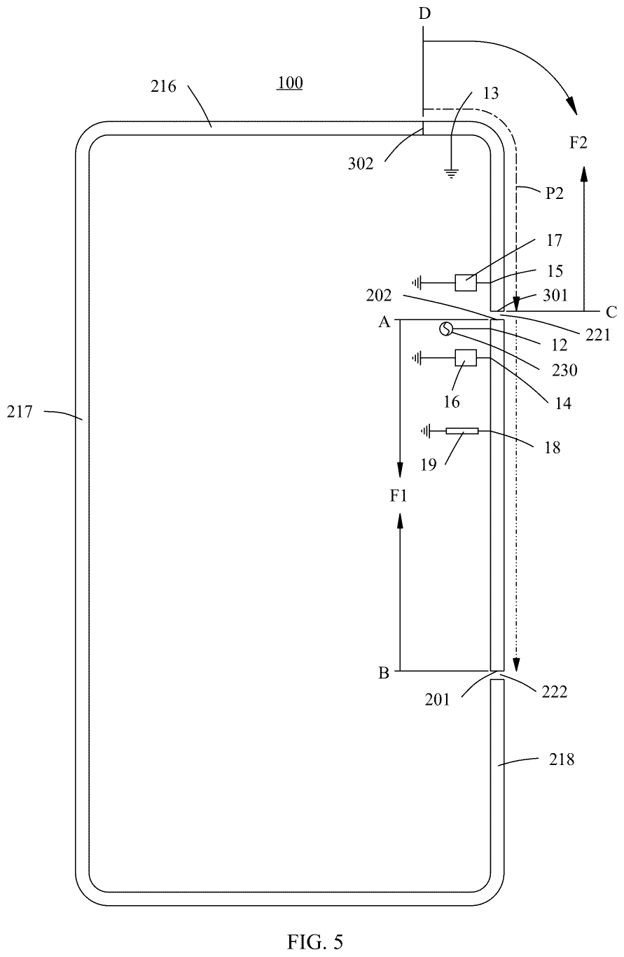

Also refer to FIG. 5. FIG. 5 is a circuit of a current path of the antenna 100. When the current is fed in from the feed point 12, the current flows through the first radiator F1 and flows to the second slot 222 (refer to a path P1), to stimulate the first operating mode to generate a radiation signal in the first band. In this embodiment, the first operating mode is a low band (LB) mode. The band of the first band may include, but is not limited to, bands such as LTE B28/B5/B8. In this way, the second slot 222 and the first radiator F1 may be coupled and resonated to obtain a mode having adjustability and higher antenna efficiency, so that frequencies in the low band of the first radiation portion F1 cover 698 MHz to 960 MHz.

When the current is fed in from the feed point 12, the current further flows through a part that is of the second radiator F2 and that is located in the second part 218, and flows to the first slot 221 (refer to a path P2), to stimulate the second operating mode to generate a radiation signal in the second band. In this embodiment, the second operating mode is a middle/high band (MHB) mode. The frequencies of the second band may include, but are not limited to, bands such as LTE B1/B3/B4/B7/B38/B39/B40/B41, WCDMA B1/B2, and GSM1800/1900. In this way, the first slot 221 and the second radiator F2 may be coupled and resonated to obtain a mode having adjustability and higher antenna efficiency, so that frequencies in the middle/high band of the second radiation portion F2 cover 1710 MHz to 2690 MHz.

In this embodiment, the first operating mode is a Long Term Evolution Advanced (LTE-A) low-frequency mode, and the second operating mode includes an LTE-A middle/high frequency mode.

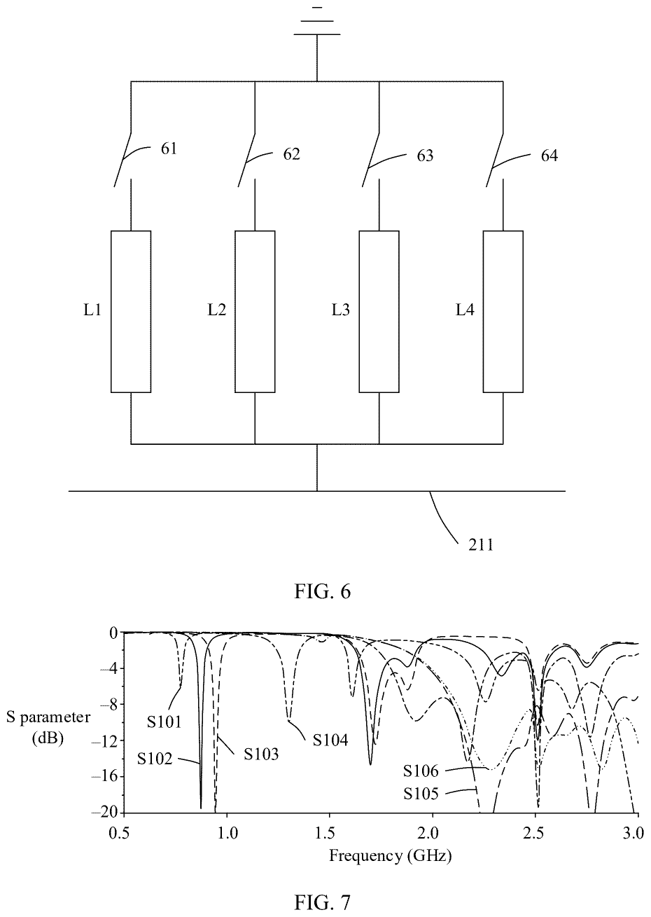

It may be understood that the tuning units mentioned above, for example, the first tuning unit 16 and the second tuning unit 17, may be both, but are not limited to, a combination of a plurality of single-pole single-throw (SPST) switches. For example, also refer to FIG. 6. The tuning unit may include at least one switch unit, for example, four SPST switches, that is, a switch 61, a switch 62, a switch 63, and a switch 64. One end of each switch unit is grounded, and the other end thereof may be connected to a corresponding tuning branch. For example, the switch 61 is connected to a tuning branch L1, the switch 62 is connected to a tuning branch L2, the switch 63 is connected to a tuning branch L3, and the switch 64 is connected to a tuning branch L4. The tuning branches L1, L2, L3, and L4 each may include a capacitor or an inductor. The tuning units may selectively turn on different tuning branches to implement frequency adjustment.

Certainly, in another embodiment, the tuning unit, for example, the first tuning unit 16 and the second tuning unit 17, may further include another type of switch unit, and is not limited to the SPST switch described above.

FIG. 7 is a curve diagram of an S parameter (scattering parameter) of the antenna 100. A curve S101 is an S11 value when the antenna 100 operates in an LTE B28 band. A curve S102 is an S11 value when the antenna 100 operates in an LTE B5 band. A curve S103 is an S11 value when the antenna 100 operates in an LTE B8 band and an LTE B3 band. A curve S104 is an S11 value when the antenna 100 operates in an LTE B1 band. A curve S105 is an S11 value when the antenna 100 operates in an LTE B40 band. A curve S106 is an S11 value when the antenna 100 operates in an LTE B7 band.

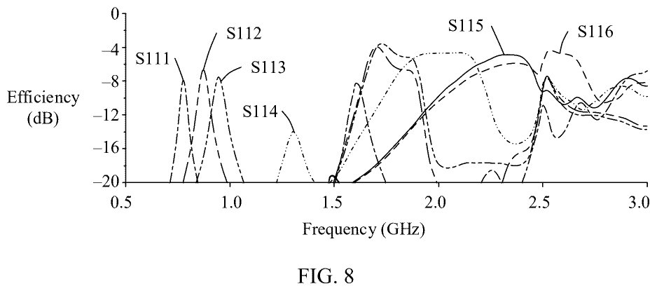

FIG. 8 is a curve diagram of radiation efficiency of the antenna 100. A curve S111 is total radiation efficiency of the antenna 100 when the antenna 100 operates in the LTE B28 band. A curve S112 is total radiation efficiency of the antenna 100 when the antenna 100 operates in the LTE B5 band. A curve S113 is total radiation efficiency of the antenna 100 when the antenna 100 operates in the LTE B8 band and the LTE B3 band. A curve S114 is total radiation efficiency of the antenna 100 when the antenna 100 operates in the LTE B1 band. A curve S115 is total radiation efficiency of the antenna 100 when the antenna 100 operates in the LTE B40 band. A curve S116 is total radiation efficiency of the antenna 100 when the antenna 100 operates in the LTE B7 band.

Apparently, it may be learned from FIG. 7 and FIG. 8 that, when the length of the first radiator F1 is one half of the wavelength corresponding to the low frequency, the low band (LB) performance of the first radiator F1 is at least 1.5 dB higher than that of a conventional solution (that is, the length of the first radiator F1 is one quarter of the wavelength corresponding to the low frequency), a lowest low band peak efficiency is −7.3 dB, and middle/high full band efficiency is greater than −5 dB.

It may be understood that, as described above, in this embodiment, the frame body of the antenna 100 directly includes the side frame 211 of the electronic device 200. In one embodiment, the housing (side frame) of the electronic device 200 is made of a metal material, and the antenna 100 is a metal side frame antenna, or may be in another antenna form such as an in-mold decoration antenna (mode decoration antenna, MDA). For example, when the antenna 100 is an MDA antenna, a metal part in the housing of the electronic device 200 is used as the frame body to implement a radiation function. The housing of the electronic device 200 is made of an insulation material such as plastic, and the metal part is integrated with the housing through insert molding.

In conclusion, in a case in which the full curved screen is increasingly optimal, the antenna 100 in this application can simultaneously implement both middle/high band (MHB) SAR radiation performance and low band (LB) radiation performance. That is, a slot position and a slot width of the antenna is designed, to adjust a strength of a coupling current of a frame body position and a slot, so as to affect distribution concentration and dispersion degrees of a current on the frame body of the antenna. The antenna 100 disperses current by cooperating with a parasitic frame body in a middle/high band (MHB) to achieve a low SAR. In addition, a slot provided on a side may assist in improving a longitudinal component of a side. Lengthening of the main antenna branch improves performance in a middle/high band to some extent, and the parasitic antenna branch expands a middle/high band and reduces SAR. In addition, in combination with joint debugging of the switch, low band (LB) efficiency can be improved, and the performance and low SAR feature in middle/high band (MHB) can be ensured. In addition, the antenna 100 in this application uses a filter circuit, so that attenuation of antenna performance is relatively low.

A person of ordinary skill in the art should understand that the foregoing implementations are only intended to describe this application but are not intended to limit this application. Therefore, appropriate modifications and variations made to the foregoing implementations shall fall within the protection scope of this application provided that the modifications and variations fall within the essence and spirit of this application.

1. An antenna of an electronic device, wherein the antenna comprises:
a first radiator, comprising:
a feed point;
a filtered-wave return-to-ground point;
a first end portion; and
a second end portion, wherein
the feed point and the filtered-wave return-to-ground point are disposed between the first end portion of the first radiator and the second end portion of the first radiator;
a feed source electrically connected to the feed point to feed a radio frequency signal into the first radiator; and
a filter circuit
electrically connected to the filtered-wave return-to-ground point and configured to enable a radio frequency signal in a first band to pass through and ground a radio frequency signal in a second band, wherein a length of the first radiator is one half of an operating wavelength corresponding to the first band.

2. The antenna according to claim 1, wherein the antenna further comprises:
a second radiator, comprising a first end portion and a second end portion, and configured to disperse current distribution of the first radiator, wherein
the first end portion of the second radiator is disposed close to the second end portion of the first radiator;
the second end portion of the second radiator is disposed away from the first radiator;
and
a first slot exists between the first end portion of the second radiator and the second end portion of the first radiator.

3. The antenna according to claim 2, wherein the second radiator further comprises:
a ground point disposed between the first end portion of the second radiator and the second end portion of the second radiator.

4. The antenna according to claim 1, wherein the first radiator further comprises:
a first switching point disposed on the first radiator and is located between the feed point and the filtered-wave return-to-ground point.

5. The antenna according to claim 4, wherein the antenna further comprises:
a first switching circuit, wherein the first switching point is grounded using the first switching circuit; and
the first switching circuit is configured to adjust a radiation frequency of the first radiator.

6. The antenna according to claim 3, wherein the second radiator further comprises:
a second switching point disposed between the first end portion and the ground point that are of the second radiator.

7. The antenna according to claim 6, wherein the antenna further comprises:
a second switching circuit, wherein the second switching point is grounded by-using the second switching circuit; and
the second switching circuit is configured to adjust a radiation frequency of the second radiator.

8. The antenna according to claim 4, wherein
the first switching point and the feed point are disposed on the first radiator and adjacent to the first end portion of the first radiator; and
the feed point is located between the first switching point and the second end portion of the first radiator.

9. The antenna according to claim 4, wherein
the filtered-wave return-to-ground point is located between the first switching point and the first end portion of the first radiator; and
a distance between the filtered-wave return-to-ground point and the second end portion of the first radiator is less than one half of a length of the first radiator.

10-13. (canceled)

14. An electronic device, comprising an antenna, wherein the antenna comprises:
a first radiator, comprising:
a feed point;
a filtered-wave return-to-ground point;
a first end portion; and
a second end portion, wherein
the feed point and the filtered-wave return-to-ground point are disposed between the first end portion of the first radiator and the second end portion of the first radiator;
a feed source electrically connected to the feed point to feed a radio frequency signal into the first radiator; and
a filter circuit electrically connected to the filtered-wave return-to-ground point and configured to enable a radio frequency signal in a first band to pass through and ground a radio frequency signal in a second band, wherein a length of the first radiator is one half of an operating wavelength corresponding to the first band.

15. The electronic device according to claim 14, wherein the antenna further comprises:
a second radiator, comprising a first end portion and a second end portion and configured to disperse current distribution of the first radiator, wherein
the first end portion of the second radiator is disposed close to the second end portion of the first radiator;
the second end portion of the second radiator is disposed away from the first radiator; and
a first slot exists between the first end portion of the second radiator and the second end portion of the first radiator.

16. The electronic device according to claim 15, wherein the second radiator further comprises:
a ground point disposed between the first end portion of the second radiator and the second end portion of the second radiator.

17. The electronic device according to claim 14, wherein the first radiator further comprises:
a first switching point disposed on the first radiator and is located between the feed point and the filtered-wave return-to-ground point.

18. The electronic device according to claim 17, wherein the antenna further comprises:
a first switching circuit, wherein the first switching point is grounded using the first switching circuit; and
the first switching circuit is configured to adjust a radiation frequency of the first radiator.

19. The electronic device according to claim 16, wherein the second radiator further comprises:
a second switching point disposed between the first end portion and the ground point that are of the second radiator.

20. The electronic device according to claim 19, wherein the antenna further comprises:
a second switching circuit, wherein the second switching point is grounded using the second switching circuit; and
the second switching circuit is configured to adjust a radiation frequency of the second radiator.

21. The electronic device according to claim 17, wherein
the first switching point and the feed point are disposed on the first radiator and adjacent to the first end portion of the first radiator; and
the feed point is located between the first switching point and the second end portion of the first radiator.

22. The electronic device according to claim 15, wherein the electronic device comprises:
a frame body, the frame body comprising:
a first side frame;
a second side frame; and
a third side frame disposed opposite of the second side frame, wherein
the first side frame is connected between the second side frame and the third side frame;
a part of the second side frame is the first radiator; and
a part of the second side frame and a part of the first side frame are the second radiator.

23. The electronic device according to claim 22, wherein the electronic device further comprises:
a backplane disposed on an edge of the frame body; and
a display unit disposed on a side of the frame body and away from the backplane.

24. The electronic device according to claim 22, wherein the electronic device further comprises
a housing, wherein the frame body is disposed in the housing and integrated with the housing through insert molding.
